(19) United States
(12) Patent Application Publication
(10) Pub. No.: US 2007/0267602 A1
(43) Pub. Date: Nov. 22, 2007

(54) Method of Manufacturing Carbon Nanotubes Paste

(76) Inventor: Shie-Heng Lee, Guanyin Township (TW)

Correspondence Address: HDSL, 4331 STEVENS BATTLE LANE, FAIRFAX, VA, 22033, US

(21) Appl. No.: 11/419,235

(22) Filed: May 19, 2006

(51) Int. Cl. H01B 1/04; B01F 17/00; D01F 9/12

(52) U.S. Cl. 252/502; 423/447.1; 516/32

(57) ABSTRACT

A method of manufacturing carbon nanotube paste first dissolves or disperses carbon nanotube into a large amount of solvent of low boiling point to prepare carbon nanotube diluted solution. The carbon nanotube diluted solution is then mixed with carbon nanotube paste liquid for mesh-printing. A concentration step removes the solvent of low boiling point from the mixed solution. Therefore, the carbon nanotube can be uniformly dispersed in the carbon nanotube paste and the viscosity of the carbon nanotube paste can be well controlled.

### BACKGROUND OF THE INVENTION

1. Field of the Invention

The present invention relates to a method of manufacturing nano structure paste, especially to a method of manufacturing carbon nanotube paste.

2. Description of Prior Art

Carbon nanotubes (CNT) are cylindrical carbon molecules with novel properties that make them potentially useful in a wide variety of applications (e.g., nano-electronics, optics, materials applications, etc.). They exhibit extraordinary strength like graphite due to Sp2 covsalent boond between molecules. Moreover, the carbon nanotubes also have unique electrical properties to render them as excellent electron emitters, emitting electrons at very low voltage, which makes them potentially useful in flat panel display.Mesh-printing is one of technologies for manufacturing carbon nanotube electron emitters. However, there are some technology difficulties. The aggregation might have separation more than 10 μm and diameter more than 20 μm because the aggregation has broad range of diameters. The viscosity of the carbon nanotube paste should be carefully selected. The pattern has residue when the viscosity of the carbon nanotube paste is too high. High-definition pattern cannot be formed due to dessolving problem when the viscosity of the carbon nanotube paste is too low.

The current carbon nanotube electron emitters also have problem of poor surface flatness and resolution. The gap between the electron emitter layer and gate layer is hard to be uniform. Therefore, the emitted electron number at different position of the electron emitter layer is different and the display image is not uniform.

The non-uniform distribution of carbon nanotube can be attributed to its long link, large molecule size and large aggregation. Therefore, the carbon nanotube is hard to dissolve in organic or inorganic solution. Moreover, the solution for carbon nanotube generally has high viscosity, usually more than 50,000 cps. The aggregation of carbon nanotube modules will be more serious when the long-link carbon nanotube and the high-viscosity carbon nanotube paste are mixed. The solution of carbon nanotube will have non-uniform distribution. The problem will be more serious if more carbon nanotubes are added.

The conventional method for preparing carbon nanotube solution has following steps to reduce non-uniform distribution.

Step 1: Preparing carbon nanotube solution: Carbon nanotube powder of small amount is added to solution of large volume, where the solution is alcohol solution and dispenser can be added.

Step 2: Dispersing the carbon nanotube: This step is generally performed by supersonic wave or stirring.

Step 3: Forming viscosity: The ethyl cellulose is dissolved in the solution of carbon nanotube by heating to convert the carbon nanotube solution to carbon nanotube paste with visvosity or cured polymer material.

The conventional surfactant uses dispenser to disperse the carbon nanotube in solution. However, the dispersion effect is limited. Moreover, in above-mentioned step 3, the aggregation occurs after sintering and the surface thickness of the electron emitter layer is not uniform. To compensate the non-uniform thickness, more carbon nanotube will be added. The weight concentration of of carbon nanotube is about 10-15% in conventinal process for carbon nanotube. The material is wasted and the cost is high.

### SUMMARY OF THE INVENTION

The present invention is intended to provide a method of manufacturing carbon nanotube paste, where the carbon nanotube can be uniformly dispersed in the carbon nanotube paste and the concentration of the carbon nanotube. Therefore, the aggregation diameter and the aggregation size variation can be reduced. The uniformity of the electron beam can be enhanced.

Moreover, the present invention is intended to provide a method of manufacturing carbon nanotube paste, where the used amount and cost of the carbon nanotube can be reduced.

Accordingly, the present invention provides a method of manufacturing carbon nanotube paste. This method firstly dissolves or disperses carbon nanotube into a large amount of solvent of low boiling point to prepare carbon nanotube diluted solution. The carbon nanotube diluted solution is then mixed with carbon nanotube paste liquid for mesh-printing. A concentration step removes the solvent of low boiling point from the mixed solution by heating or reducing pressure. Therefore, the carbon nanotube can be uniformly dispersed in the carbon nanotube paste and the aggregations can be reduced.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is flowchart for the method of manufacturing carbon nanotube paste according to the present invention.

### DETAILED DESCRIPTION OF THE INVENTION

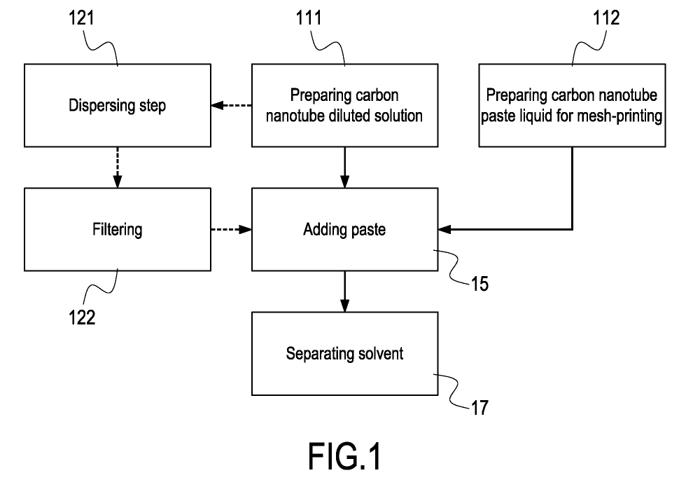

As shown in FIG. 1, a large amount of solvent of low boiling point is used to fully disperse carbon nanotube therein, thus forming a carbon nanotube diluted solution, as shown in step 111. Moreover, a carbon nanotube paste liquid for mesh printing is prepared in step 112. In step 15, the carbon nanotube diluted solution and the carbon nanotube paste liquid for mesh printing are mixed. Afterward, step for concentration is performed to remove the solvent of low boiling point in the mixed solution. The carbon nanotube paste is prepared when the viscosity of the mixed solution reaches certain value, as shown in step 17. Therefore, a carbon nanotube paste with uniform carbon nanotube can be manufactured.

The diluted solvent of low boiling point has two properties. First, it provides large dispersion effect to the carbon nanotube. Second, it can be solved with the carbon nanotube paste liquid. The low boiling property can remove solvent by reducing pressure or heating in step 17.

The carbon nanotube paste is prepared as follows. Polymer material is heated to dissolve in paste solvent to form a carbon nanotube paste with viscosity of 50000 cps. In the present invention, the polymer can be ethyl cellulose and the paste solvent is organic solvent with boiling point more larger than that of the diluted solvent.

Afterward, the carbon nanotube diluted solution is mixed with carbon nanotube paste liquid. The carbon nanotube diluted solution uses ethyl organic solvent as solvent. Therefore, the carbon nanotube diluted solution can be mixed uniformly with the carbon nanotube paste liquid, which is also an organic. In the present invention, the carbon nanotube can be uniformly dispersed in the mixed solution by stirring. The viscosity of the mixed solution is preferably lower than 1000 cps. The viscosity is still too low to be applied on mesh printing. However, the mixed solution contains large amount of solvent with low boiling point. The ethanol can be separated by heating or reducing pressure. Therefore, the viscosity of the mixed solution can be increased to a level suitable for carbon nanotube paste of mesh printing. It should be noted that the separation speed of ethanol should be limited to prevent over-large aggregations.

Moreover, step for dispersing the carbon nanotube diluted solution can be performed to increase dispersion of carbon nanotube, as shown in step 121. Step for dispersing the carbon nanotube can be performed by ultrasonic oscillation, physical way, or adding dispersion agent to increase dispersion effect of the carbon nanotube diluted solution. In step for dispersing, the physical way can be performed by high speed stirring. The dispersion agent can preferably select TX-100 (p-tert-C₈H₁₇C₆H₄(OC₂H₄)ₙOH(alkylaryl polyether alcohol)).

Moreover, filtering unit can be provided to remove large aggregations in step 122. The conventional solution has high viscosity and the large aggregations is difficult to remove. In the present invention, the carbon nanotube diluted solution has low viscosity and the large aggregations can be easily filtered.

The preferred embodiment of the present invention is described in more detail below. The carbon nanotube diluted solution is prepared by diluting 150 mg carbon nanotube with 1 liter of ethanol, where the carbon nanotube is preferably multi-wall carbon nanotube and tube length thereof is preferably less than 5 μm. The aggregation of carbon nanotube will happen when the weight of the carbon nanotube is more than 200 mg. The concentration of the carbon nanotube diluted solution is preferably 150 mg/l˜200 mg/l. Afterward, step for dispersing is used to stir to increase uniformity of the carbon nanotube in the carbon nanotube diluted solution. The step for dispersing can be performed by adding dispersion agent such as TX-100 or supersonic oscillation where the carbon nanotube bundle is dispersed by supersonic oscillation. After stirring one hour, the carbon nanotube diluted solution is filtered by filter paper to remove carbon nanotube aggregations or impurities. The carbon nanotube diluted solution is then mixed with the carbon nanotube paste liquid.

The carbon nanotube paste liquid has following content:

Butyl carbitol: 50%.;

α-terpineol: 16%, where these two alcohols are solvent for carbon nanotube paste liquid;

Ethyl cellulose: 16%, enhancing viscosity of the alcohol;

Conductive powder: 5%, enhancing the electrical conductivity of the carbon nanotube paste and electronic property of the electron emitter, and

Glass powder: 12%, enhancing the adhesive force of the electron emitter on glass substrate.

The carbon nanotube paste liquid in with above formula has viscosity more than 10000 cps. The prepared carbon nanotube paste liquid is added in one liter of carbon nanotube diluted solution in different batches of fixed amount as been detailed below. Under room temperature, carbon nanotube paste liquid of 240 g is added into the carbon nanotube diluted solution for each batch. A high speed stirring is performed to prevent deposition of suspended carbon nanotube, and the stirring speed is preferably 500 rpm.

The solvent for the carbon nanotube diluted solution is selected to provide good dispersion effect for the carbon nanotube according to the present invention. The solvent for the carbon nanotube diluted solution preferably has solubility with the carbon nanotube paste liquid. Therefore, ethanol is selected as solvent for the carbon nanotube diluted solution. The viscosity of the mixed solution of the carbon nanotube diluted solution and the carbon nanotube paste liquid is not so high such that better dispersion can be achieved by stirring. The viscosity of the mixed solution of the carbon nanotube diluted solution and the carbon nanotube paste liquid is not enough for mesh-printing. Therefore, a concentration step is performed to increase viscosity The concentration step can be various. In the preferred embodiment, the mixed solution is heated to boil such that the ethanol solution is evaporated. Alternatively, distillation by reducing pressure can be used to removed ethanol. The concentration speed should be carefully controlled. The carbon nanotube aggregation will produce and the dispersion effect is not good when the concentration speed is too fast. Undesired chemical effect for solute may occur and the carbon nanotube paste cannot be applied to mesh printing when the concentration speed is too low.

Therefore, the concentration speed of the ethanol is preferably 15 ml per minute. The viscosity of the carbon nanotube paste is measured when the removed amount of the ethanol is 850 ml. The carbon nanotube paste according to the present invention can be obtained when the viscosity of the carbon nanotube paste is 40000 cps.

In the carbon nanotube paste of the present invention, the content of the carbon nanotube is only 0.27% weight concentration, which is smaller than the 5% weight concentration in the conventional carbon nanotube paste. In the carbon nanotube paste of the present invention, the sintered aggregation diameters smaller than 10μm, and the size variation of the aggregation is smaller than 5 μm. Therefore, the surface uniformity of the electron emitter and the generation of electron can be enhanced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for preparing carbon nanotube paste, comprising:
dispersing or dissolving carbon nanotube into a large amount of diluting solvent to form a carbon nanotube diluted solution;
preparing a carbon nanotube paste liquid by solving polymer into a solvent by heating;
mixing the carbon nanotube diluted solution and the carbon nanotube paste liquid to form a mixed solution; and
performing a concentration step to the mixed solution to remove solvent to obtain a carbon nanotube paste.

2. The method for preparing carbon nanotube paste as in claim 1, wherein the step for concentration is one of heating and reducing pressure.

3. The method for preparing carbon nanotube paste as in claim 1, wherein the diluting solvent is a solvent with good dispersing and/or dissolving effect to carbon nanotube.

4. The method for preparing carbon nanotube paste as in claim 1, where the diluting solvent is a solvent with intersolubility to carbon nanotube paste.

5. The method for preparing carbon nanotube paste as in claim 1, where the diluting solvent is a solvent with low boiling point and being liquid state in room temperature.

6. The method for preparing carbon nanotube paste as in claim 1, where the diluting solvent is an organic solvent.

7. The method for preparing carbon nanotube paste as in claim 6, where the diluting solvent is ethanol.

8. The method for preparing carbon nanotube paste as in claim 6, where the concentration of the carbon nanotube in the carbon nanotube diluted solution is preferably 150 mg/l˜200 mg/l.

9. The method for preparing carbon nanotube paste as in claim 6, where the concentration rate of the mixed solution is 15 ml per minute.

10. The method for preparing carbon nanotube paste as in claim 9, further comprising:
continuing to measure a visvosity of the carbon nanotube paste and stopping the concentration step when the viscosity is 40000 cps.

11. The method for preparing carbon nanotube paste as in claim 10, wherein the viscosity of the carbon nanotube paste is kept measuring after a separation amount of the diluting solvent is more than 850 ml.

12. . The method for preparing carbon nanotube paste as in claim 1, wherein a viscosity of the carbon nanotube paste is more than 50000 cps.

13. The method for preparing carbon nanotube paste as in claim 1, wherein the polymer is ethyl cellulose.

14. The method for preparing carbon nanotube paste as in claim 1, wherein the paste solvent is organic solvent with boiling point more larger than that of the diluted solution.

15. The method for preparing carbon nanotube paste as in claim 1, wherein a stirring step is used to mix the carbon nanotube diluted solution and the carbon nanotube paste liquid to form a mixed solution.

16. The method for preparing carbon nanotube paste as in claim 1, wherein a viscosity of the mixed solution is smaller than 1000 cps.

17. The method for preparing carbon nanotube paste as in claim 1, further comprising:
increasing dispersion of carbon nanotube in the carbon nanotube diluted solution by dispersing step.

18. The method for preparing carbon nanotube paste as in claim 17, wherein the dispersing step uses supersonic wave to oscillate the carbon nanotube diluted solution.

19. The method for preparing carbon nanotube paste as in claim 17, wherein the dispersing step uses high-speed stirring.

20. The method for preparing carbon nanotube paste as in claim 17, wherein the dispersing step adds dispersion agent.

21. The method for preparing carbon nanotube paste as in claim 20, wherein the dispersion agent is TX-100 (p-tert-C₈H₁₇C₆H₄(OC₂H₄)ₙOH(alkylaryl polyether alcohol)).

22. The method for preparing carbon nanotube paste as in claim 1, further comprising:
using filter unit to remove large aggregation.

23. The method for preparing carbon nanotube paste as in claim 1, wherein a solvent for the carbon nanotube paste liquid is an organic solvent with boiling point more larger than that of the carbon nanotube diluted solution.

24. The method for preparing carbon nanotube paste as in claim 23, wherein the carbon nanotube paste liquid comprises butyl carbitol.

25. The method for preparing carbon nanotube paste as in claim 24, wherein a weight concentration of the butyl carbitol is 50%.

26. The method for preparing carbon nanotube paste as in claim 23, wherein the carbon nanotube paste liquid comprises a-terpineol.

27. The method for preparing carbon nanotube paste as in claim 26, wherein a weight concentration of the a-terpineol is 16%.

28. The method for preparing carbon nanotube paste as in claim 23, wherein the carbon nanotube paste liquid comprises ethyl cellulose.

29. The method for preparing carbon nanotube paste as in claim 28, wherein a weight concentration of the ethyl cellulose is 16%.

30. The method for preparing carbon nanotube paste as in claim 23, wherein the carbon nanotube paste liquid comprises glass powder.

31. The method for preparing carbon nanotube paste as in claim 30, wherein a weight concentration of the glass powder is 16%.

32. The method for preparing carbon nanotube paste as in claim 1, wherein a viscosity of the carbon nanotube paste liquid is more than 10000 cps.

33. The method for preparing carbon nanotube paste as in claim 1, wherein the carbon nanotube paste liquid is added in different batches with fixed amount and the mixed solution is stirred in high speed.

34. The method for preparing carbon nanotube paste as in claim 33, wherein the fixed amount is 240 g carbon nanotube paste liquid added in one liter of carbon nanotube diluted solution.

35. The method for preparing carbon nanotube paste as in claim 33, wherein the stirring speed is 500 rpm.

36. The method for preparing carbon nanotube paste as in claim 1, wherein the carbon nanotube is multi-wall carbon nanotube.

37. The method for preparing carbon nanotube paste as in claim 1, wherein a length of the carbon nanotube is smaller than 5 μm.
